(19) United States
(12) Patent Application Publication
(10) Pub. No.: US 2026/0227289 A1
(43) Pub. Date: Aug. 6, 2026

(54) TRANSDUCER UNIT FOR MEASURING FORCE AND/OR TORQUE ON WHEELS OF A VEHICLE, AND MEASURING WHEEL FOR A VEHICLE WITH SUCH A TRANSDUCER UNIT

(71) Applicant: Kistler Holding AG, Winterthur (CH)

(72) Inventors: Christian Oram, Berg am Irchel (CH); Gerd Moessinger, Lauchringen (DE)

(21) Appl. No.: 19/454,866

(22) Filed: Jan. 21, 2026

(30) Foreign Application Priority Data
Jan. 31, 2025 (EP) 25155179.2

(51) Int. Cl. G01M 17/013; G01K 7/25; G01L 1/16

(52) U.S. Cl. CPC G01M 17/013; G01K 7/25; G01L 1/16

(57) ABSTRACT

A transducer unit for measuring force and torque on the wheels of a vehicle includes a plurality of measuring units in a housing that transmits the force and torque to the measuring units that generate an electric charge proportional to the force and torque. A feedthrough attached to the housing conducts the electrical charge outside of the housing. An additional feedthrough attached to the housing conducts additional electrical charge into the housing.

### TECHNICAL FIELD

The invention relates to a transducer unit for measuring force and/or torque on the wheels of a vehicle, as well as a measuring wheel for a vehicle comprising such a transducer unit.

### BACKGROUND OF THE INVENTION

In vehicle development, measuring wheels are used to determine operating load data during vehicle operation. The operating load data takes into account essential parameters of vehicle operation such as mass, inertia, air and rolling resistance, engine load, speed and the like. From the operating load data important findings into the operating characteristics of the vehicle can be gained.

Such a measuring wheel is mounted on the vehicle in place of a standard wheel. The measuring wheel comprises a plurality of transducers for measuring the force and/or torque acting on the measuring wheel during operation of the vehicle. Said transducers are arranged on the rim of the measuring wheel at equal distances from the hub and from each other. The force and/or torque are introduced into the measuring wheel via the tire contact patch. The transducers provide a measurement signal for the measured force and/or torque. The operating load data are determined from the measurement signal.

EP2116833B1, which corresponds to applicant's commonly owned U.S. Pat. No. 7,784,336 that is hereby incorporated herein in its entirety for all purposes, discloses such a transducer for measuring force and/or torque on the wheels of a vehicle. Said transducer comprises quartz elements which are arranged in a housing which is called a load cell. Said load cell completely surrounds the quartz elements, protecting them from harmful environmental influences such as dust, moisture, direct contact and the like. The transducer can be attached to the measuring wheel via the load cell. The load cell absorbs the force and/or torque and transmits it to the quartz elements. The quartz elements operate according to the piezoelectric measuring principle and generate an electrical charge as a measuring signal under the effect of the force and/or torque. Said transducer comprises electrical conductors and a feedthrough. The feedthrough is attached to the load cell. The electrical charge is conducted from the quartz elements to the feedthrough via the electrical conductors. Said feedthrough conducts the electrical charge to the outside the load cell.

The measuring wheel also comprises an electronic circuit that amplifies the electrical charge of the transducers and converts it into an electrical voltage. Such a measuring wheel with multiple transducers and an electronic circuit is known as type 9299A from data sheet 9299A_000_993e_02.14. Said electrical circuit is located on the hub of the measuring wheel. The measuring wheel comprises measuring cables that electrically connect the feedthroughs of the transducers to the electrical circuit. The Type 9299A measuring wheel comprises six transducers, each with one feedthrough in the load cell. The two feedthroughs of two directly adjacent transducers are electrically connected to each other via a measuring cable. This means that six transducers are connected in series via five measuring cables. A sixth measuring cable connects the six transducers connected in series to the electronic circuit.

Now, during operation of said measuring wheel, the measuring cables are exposed to environmental influences such as stone chipping, moisture and the like, and can be damaged, which impairs the availability of the measuring wheel. The measuring cables are also laid around the individual load cells to the feedthrough of the transducer, which is time-consuming. Finally, the measuring cables are bent when laid around the measuring cells. This bending leads to mechanical stresses. During operation of the measuring wheel, the measuring cables can relax mechanically and move. This movement of the measuring cables generates electrical interference charges due to friction in the measuring cable, which can interfere with the electrical charge derived in the measuring cable and distort the measurement of force and/or torque.

### OBJECTS AND SUMMARY OF THE INVENTION

It is an object of the present invention to improve the measuring wheel of type 9299A.

This object is achieved by the features described herein.

The invention relates to a transducer unit for measuring force and/or torque on the wheels of a vehicle. The transducer unit desirably includes a plurality of measuring units and a housing in which the measuring units are arranged. The housing is configured and disposed to transmit the force and/or torque to the measuring units, which operate according to the piezoelectric measuring principle and are configured to generate an electrical charge under the effect of the force and/or torque that is being measured. The transducer unit desirably includes a plurality of electrical conductors and a feedthrough. The electrical conductors are arranged in the housing and configured and disposed to conduct the electrical charge from the measuring units to the feedthrough, which is attached to the housing and configured and disposed to conduct the electrical charge to the outside of the housing. The transducer unit desirably includes an additional feedthrough and an additional electrical conductor. The additional feedthrough is attached to the housing and configured and disposed to conduct additional electrical charge from the outside of the housing into the housing. The additional electrical conductor is arranged in the housing and configured and disposed to conduct the additional electrical charge from the additional feedthrough to the feedthrough.

The invention also relates to a measuring wheel for a vehicle and includes a plurality of transducer units for measuring force and/or torque on the wheels of the vehicle. The measuring wheel is designed to be mounted on the vehicle in a manner so that in this state of attachment to the vehicle, the force and torque to be measured is acting on the mounted measuring wheel. Each transducer unit includes a plurality of measuring units and a housing in which the measuring units are arranged. The housing is designed to be attached to the measuring wheel and, when the housing is attached to the measuring wheel, the housing is configured and disposed to transmit the force and/or torque to the measuring units inside the housing. The measuring units operate according to the piezoelectric measuring principle and generate an electrical charge under the effect of the force and/or torque that is so be measured. Each transducer unit includes a plurality of electrical conductors and a feedthrough, which electrical conductors are arranged in the housing and conduct the electrical charge from the measuring units to the feedthrough, which is attached to the housing and which is configured and disposed to conduct the electrical charge to the outside of the housing. At least one transducer unit includes an additional feedthrough and an additional electrical conductor. The additional feedthrough is attached to the housing and configured and disposed to conduct additional electrical charge from the outside of the housing into the housing. The additional electrical conductor is arranged in the housing and configured and disposed to conduct the additional electrical charge from the additional feedthrough to the feedthrough.

Advantageous embodiments of the invention are described in more detail hereinafter.

### BRIEF DESCRIPTION OF THE DRAWINGS

In the following, the invention is explained in more detail by way of example in more detail below with reference to the figures, in which:

FIG. 1 shows a schematic view of part of a measuring wheel 1 for a vehicle with a plurality of transducer units 2, 3-3″;

FIG. 2 shows a perspective view of part of a dual summing transducer unit 2 of the measuring wheel 1 according to FIG. 1;

FIG. 3 shows a top view of a part of the dual summing transducer unit 2 according to FIG. 2 with the cover plate 201 removed;

FIG. 4 shows a perspective view of a part of a triple summing transducer unit 3-3″ of the measuring wheel 1 according to FIG. 1;

FIG. 5 shows a top view of a part of the triple summing transducer unit 3-3″ according to FIG. 4 with the cover plate 301 removed;

FIG. 6 shows a perspective view, partially in section, of a part of a feedthrough 25 of the dual summing transducer unit 2 according to FIGS. 2 and 3;

FIG. 7 shows a perspective view, partially in section, of a part of a feedthrough 35-35″ of the triple summing transducer unit 3-3″ according to FIGS. 4 and 5;

FIG. 8 shows a perspective view, partially in section, of a part of an additional feedthrough 36 of the triple summing transducer unit 3-3″ according to FIGS. 4 and 5;

FIG. 9 shows a perspective view of a part of an electronic circuit 4 of the measuring wheel 1 according to FIG. 1;

FIG. 10 shows a cross-sectional view cut in a plane along the dot dash line in FIGS. 3 and 5 and looking in the direction in which the arrows A - A are pointing in FIGS. 3 and 5; and

FIG. 11 shows a cross-sectional view in a plane extending in the direction in which the arrows B-B are pointing in FIG. 9; and

FIG. 12 shows a schematic representation of the circuit elements shown in cross-sectional view in FIG. 11.

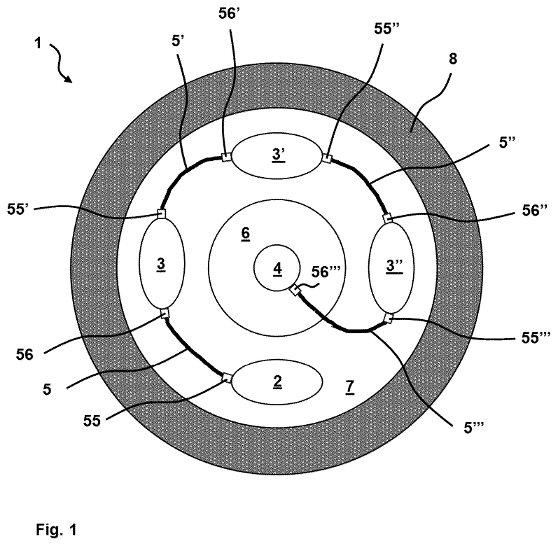

Identical reference numerals denote identical objects in the figures. Identical objects of said measuring wheel 1, which are shown repeatedly in FIG. 1, are distinguished by apostrophes after the reference numeral.

### DETAILED DESCRIPTION OF EXEMPLARY EMBODIMENTS OF THE INVENTION

FIG. 1 shows a schematic view of part of a measuring wheel 1 for a vehicle (not shown).

The vehicle is designed to be moved on a roadway (not shown) in the usual manner. The vehicle is in contact with the roadway via at least one wheel. For example, the vehicle is a motor vehicle, a railway and the like. The vehicle, the wheel, and the roadway are not shown together in the figure.

### The Measuring Wheel 1

Said measuring wheel 1 is configured to perform the function of absorbing the force and/or torque acting on the measuring wheel during operation of the vehicle in order to determine operating load data from this dynamic interaction with the roadway during the vehicle's travel on the roadway. As shown in FIG. 1, said measuring wheel 1 comprises a hub 6, a rim 7, a tire 8, and a plurality of mounting means. The measuring wheel 1 is designed to be mounted via the mounting means on the vehicle in place of a wheel that normally would be part of the vehicle to measure the forces and torques that would apply to the normal wheel of the vehicle. The mounting means are any of the conventional structures for mounting a wheel to a vehicle and thus are not shown in the figure.

When assembled onto the vehicle, said measuring wheel 1 is in contact with the road surface via said tire 8. The point of contact is not shown in FIG. 1 but is actually the tire's area that becomes deformed from its undeformed cylindrical shape when in contact with the roadway, and this area is referred to as the tire contact patch. The force and/or torque is transmitted to the measuring wheel 1 via the tire contact patch.

The force and/or torque is constituted by a plurality of components. Preferably, the force and/or torque each comprises three components. Each of the three components acts along a different coordinate of a three-dimensional coordinate system. The measuring wheel 1 is configured and disposed so as to absorb at least one component of the force and/or torque. The force and/or torque are/is not schematically shown in FIG. 1.

As shown in FIG. 1, said measuring wheel 1 comprises a plurality of transducer units 2, 3-3″ that are configured and disposed for measuring at least one of the force and torque affecting the measuring wheel during operation of the vehicle. Said transducer units 2, 3-3″ are arranged on the rim 7 at equal distances from the hub 6 and from each other. The transducer units 2, 3-3″ are configured to perform the function of providing a measurement signal for the force and/or torque that is introduced into the measuring wheel 1 via the tire contact patch.

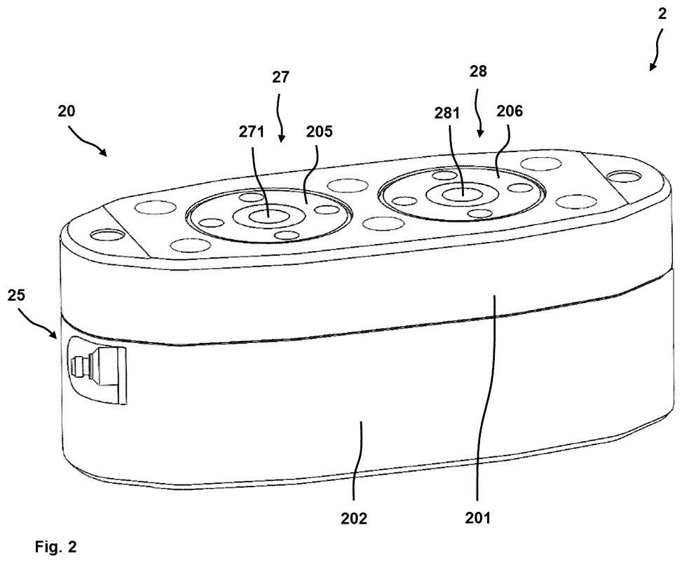

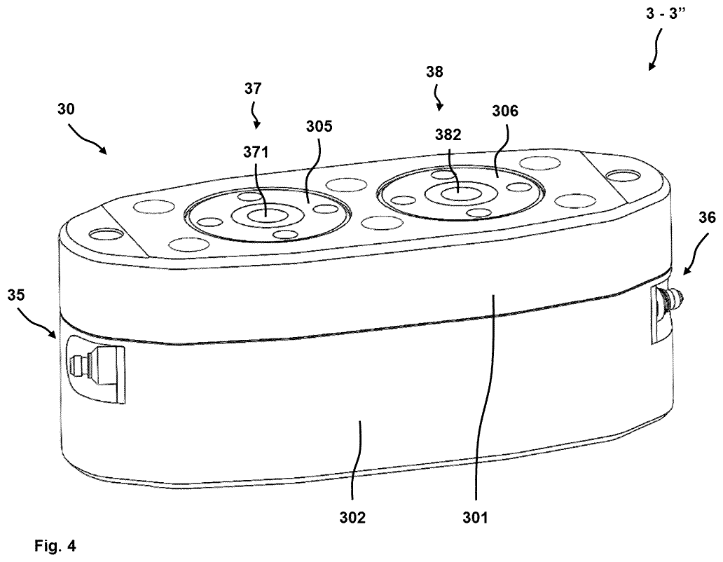

In the case of transducer units 2, 3, 3′ and 3″, there exists a differentiation between the arrangement of components constituting a dual summing transducer unit 2 and the arrangement of components constituting each of the three triple summing transducer units 3, 3′ and 3″. FIGS. 2, 3, and 6 depict details of the arrangement of components constituting a dual summing transducer unit 2. FIGS. 4, 5, 7, and 8 depict details of the arrangement of components constituting each triple summing transducer unit 3, 3′ and 3″.

The view shown in FIG. 1 depicts, for example, four transducer units 2, 3-3″. The four transducer units 2, 3-3″ comprise a dual summing transducer unit 2, a first triple summing transducer unit 3, a second triple summing transducer unit 3′ and a third triple summing transducer unit 3″. Each of the three triple summing transducer units 3, 3′ and 3″ is configured with means of connection at each opposite end thereof. Accordingly, with this knowledge of the present invention, a person skilled in the art can implement a measuring wheel with more than four or fewer than four transducer units.

### The Housing 20, 30

Each respective transducer unit 2, 3-3″ comprises a respective housing 20, 30 and a plurality of measuring units 21, 22, 31, 32 disposed within an interior space defined within the respective housing 20, 30.

Said housing 20, 30 is configured and disposed to perform the function of protecting the measuring units 21, 22, 31, 32 from harmful environmental influences such as dust, moisture, direct mechanical contact and the like.

Said housing 20, 30 is made of mechanically resistant material such as stainless steel. Preferably, said housing 20, 30 comprises multiple parts that are connected together to form the entire housing 20, 30.

Said housing 20, 30 desirably comprises a cover plate 201, 301 and a mating base plate 202, 302. Each respective cover plate 201, 301 is configured as a half shell that includes a generally planar upper portion, from which depends a generally cylindrical side portion that aligns perpendicularly to the upper portion. Similarly, each respective base plate 202, 302 is configured as a half shell that includes a generally planar lower portion, from which extends a generally cylindrical side portion that aligns perpendicularly to the lower portion. The respective side portion of each respective cover plate 201, 301 is configured to mate together with the respective side respective portion of each respective base plate 202, 302 to form the respective housing 20, 30.

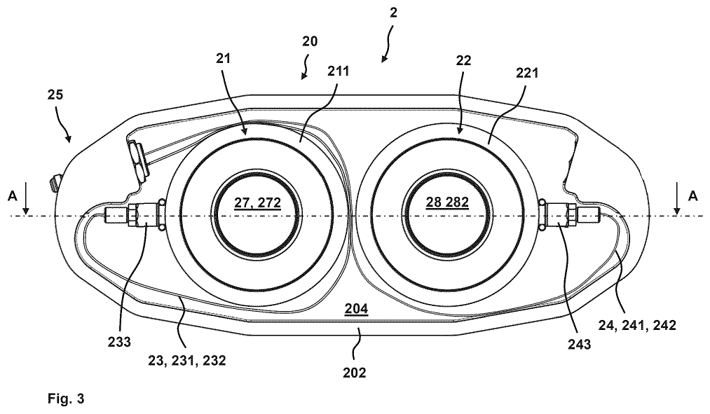

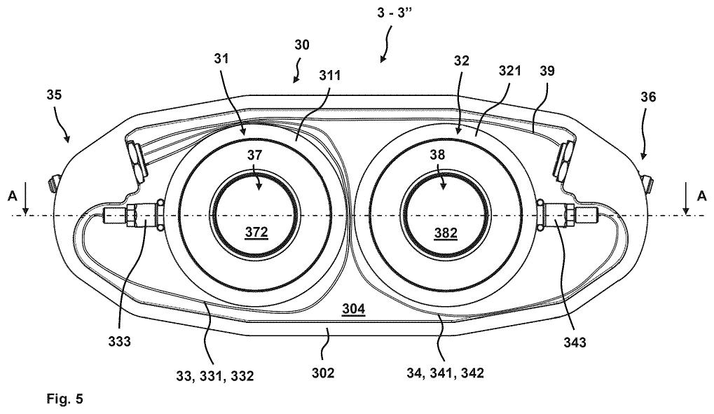

FIG. 2 shows the housing 20 of the dual summing transducer unit 2 in perspective view with a cover plate 201 and a base plate 202. FIG. 3 shows the housing 20 of the dual summing transducer unit 2 in top view with the cover plate 201 removed. FIG. 4 shows the housing 30 of the triple summing transducer unit 3, 3′ and 3″ in perspective view with a cover plate 301 and a base plate 302. FIG. 5 shows the housing 30 of the triple summing transducer unit 3, 3′ and 3″ in a top view with the cover plate 301 removed.

Said cover plate 201, 301 and said base plate 202, 302 are connected to each other by connecting means. An example of a suitable connecting means is mentioned below in connection with components performing a preload function. The connection between the cover plate 201, 301 and the base plate 202, 302 is tight. For the purposes of the present invention, tightness means compliance with protection class IP65 according to DIN EN 60529, preferably compliance with protection class IP67 according to DIN EN 60529. Compliance with protection class IP65 prevents the ingress of dust and provides complete protection against contact and against water jets from any angle. Compliance with protection class IP67 prevents the ingress of dust and offers complete protection against contact and immersion in water.

Said housing 20, 30 comprises a plurality of fastening means. The housing 20, 30 is designed to be fastened to the measuring wheel 1 via the fastening means, which desirably are conventional components like screws and/or bolts. Accordingly, the fastening means are not shown in the figure.

### The Measuring Units 21, 31, 22, 32

Said measuring units 21, 22, 31, 32 are configured to perform the function of generating a measuring signal for the force and/or torque that is introduced into measuring wheel 1 via said tire contact patch. Desirably, the measuring signal that is generated is an analog signal that captures as much information about the force and torque as possible.

Said measuring units 21, 22, 31, 32 are disposed in the interior space inside the housing 20, 30. Preferably, two measuring units 21, 22, 31, 32 are arranged inside each housing 20, 30. However, knowledge of the present invention suffices to inform a person skilled in the art how to implement a transducer unit with more or fewer than two measuring units inside each housing 20, 30.

According to the top view looking into the interior of the base plate 202 in FIG. 3, the dual summing transducer unit 2 comprises two measuring units 21, 22, which comprise a left measuring unit 21 and a right measuring unit 22. According to the top view looking into the interior of the base plate 202 in FIG. 5, the triple summing transducer unit 3, 3′ and 3″ comprises two measuring units 31, 32, which comprise a left measuring unit 31 and a right measuring unit 32.

Preferably, as schematically shown in FIGS. 3 and 5, said base plate 202, 302 defines a recess 204, 304 by the interior walls of the cylindrical side portion and lower portion of the base plate 202, 302. According to the top view of the dual summing transducer unit 2 in FIG. 3, the measuring units 21, 22 are arranged within the recess 204. According to the top view of the triple summing transducer unit 3, 3′and 3″ in FIG. 5, the measuring units 31, 32 are arranged within said recess 304.

Said housing 20, 30 comprises a plurality of covers 205, 206, 305, 306. As schematically shown in FIGS. 2, 4 and 10, the covers 205, 206, 305, 306 are disc-shaped.

According to the view shown in FIG. 2, the dual summing transducer unit 2 comprises two covers 205, 206, which comprise a left cover 205 and a right cover 206. According to the view shown in FIG. 4, the triple summing transducer unit 3-3″ comprises two covers 305, 306, which comprise a left cover 305 and a right cover 306.

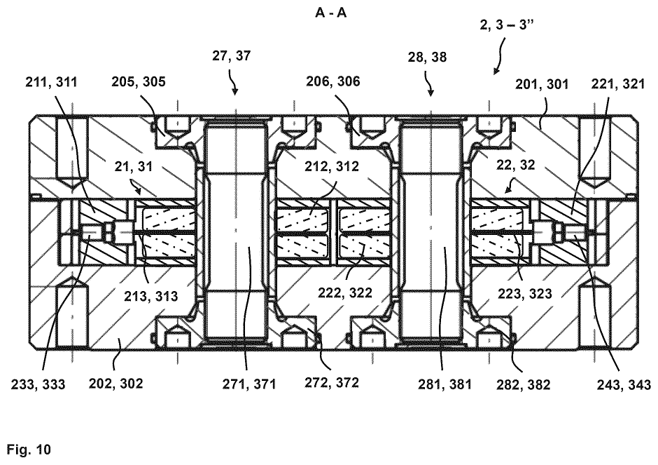

Said housing 20, 30 is designed to transmit the force and/or torque to the measuring units 21, 22, 31, 32 via said covers 205, 206, 305, 306 when the cover plate 201, 301 is fastened to the base plate 202, 302. As schematically shown in FIG. 10 for example, the covers 205, 206, 305, 306 are arranged in openings defined in the cover plate 201, 301. The openings in the cover plate 201, 301 extend from the outside of the housing 20, 30 to the measuring units 21, 22, 31, 32 disposed in the recess 204, 304 defined in the base plate 202, 302. The covers 205, 206, 305, 306 arranged in the openings of said cover plate 201, 301 are located directly above the measuring units 21, 22, 31, 32 in the recess 204, 304 and transmit the force and/or torque to the measuring units 21, 22, 31, 32. According to the view of the dual summing transducer unit 2 in FIGS. 2 and 10, the left cover 205 is arranged directly above the left measuring unit 21 in a vertical direction, and the right cover 206 is arranged directly above the right measuring unit 22 in a vertical direction. According to the view of the triple summing transducer unit 3, 3′ and 3″ in FIGS. 4 and 10, the left cover 305 is arranged directly above the left measuring unit 31 in a vertical direction, and the right cover 306 is arranged directly above the right measuring unit 32 in a vertical direction.

As schematically shown in FIGS. 2 and 4, each respective transducer unit 2, 3, 3′ and 3″ comprises a plurality of preload units 27, 28, 37, 38. Each respective one of the preload units 27, 28, 37, 38 is configured to perform the function of mechanically preloading the respective one of the plurality of measuring units 21, 22, 31, 32. Due to the mechanical preload, each measuring unit 21, 22, 31, 32 is assigned a baseline reading, and the measuring units 21, 22, 31, 32 can then measure both a positive force and/or a positive torque as well as a negative force and/or a negative torque relative to the baseline reading established by the preloading of the respective measuring unit 21, 22, 31, 32.

According to the view of FIG. 2, the dual summing transducer unit 2 comprises a left preload unit 27 for the left cover 205 and the left measuring unit 21, and a right preload unit 28 for the right cover 206 and the right measuring unit 22. According to the view shown in FIG. 4, the triple summing transducer unit 3, 3′ and 3″ for the left cover 305 and the left measuring unit 31 comprises a left preload unit 37, and for the right cover 306 and the right measuring unit 32 it comprises a right preload unit 38.

Each preload unit 27, 28, 37, 38 comprises a respective preload screw 271, 281, 371, 381 identified in FIGS. 2, 4 and 10, and a respective preload bore 272, 282, 372, 382 identified in FIGS. 3, 5 and 10 is associated with each respective preload screw 271, 281, 371, 381. Moreover, this interaction between the preload screws 271, 281, 371, 381 and preload bore 272, 282, 372, 382 is configured and disposed to provide connecting means by which the respective cover plate 201, 301 and the respective associated base plate 202, 302 are connected to each other.

According to the view of the dual summing transducer unit 2 shown in FIGS. 2 and 10, the left preload unit 27 comprises a left preload screw 271 and the right preload unit 28 comprises a right preload screw 281. According to the top view of the dual summing transducer unit 2 shown in FIG. 3 and cross-sectional view of FIG. 10, the left preload unit 27 comprises a left preload bore 272 and the right preload unit 28 comprises a right preload bore 282. According to the view of the triple summing transducer unit 3, 3′ and 3″ shown in FIGS. 4 and 10, the left preload unit 37 comprises a left preload screw 371 and the right preload unit 38 comprises a right preload screw 381. According to the top view of the triple summing transducer unit 3-3″ shown in FIG. 5 and cross-sectional view of FIG. 10, the left preload unit 37 comprises a left preload bore 372 and the right preload unit 38 comprises a right preload bore 382.

The preload bores 272, 282, 372, 382 are defined in the base plate 202, 302. Each cover 205, 206, 305, 306 defines a central opening. Each of the preload screws 271, 282, 371, 381 protrudes with a threaded section through the central opening of one of the covers 205, 206, 305, 306. As schematically shown in FIG. 10, for each housing 20, 30, the head portion of the preload screw 271, 282, 371, 381 rests on a countersink defined in the cover 205, 206, 305, 306 so that the head portion does not protrude above the surface of the cover 205, 206, 305, 306. The mechanical preload of the measuring units 21, 22, 31, 32 is achieved by means of screw connections of the preload screws 271, 272, 371, 381 with the preload bore

272, 282, 372, 382 associated to them. The arrangement of the covers 205, 206, 305, 306 in the central openings of the cover plate 201, 301 and the contact of the preload screws 271, 281, 371, 381 with the covers 205, 206, 305, 306 is tight in the sense of the present invention.

The measuring units 21, 22, 31, 32 are constructed in the same way. As schematically shown in FIGS. 3, 5 and 10, each respective measuring unit 21, 22, 31, 32 comprises a respective ring body 211, 221, 311, 321 made of mechanically resistant material such as stainless steel. Said ring body 211, 221, 311, 321 encloses an interior space of the measuring unit 21, 22, 31, 32. As schematically shown in FIG. 10, piezoelectric material 212, 222, 312, 322 such as quartz, gallium orthophosphate and the like, and electrodes 213, 223, 313, 323 made of electrically conductive material, are arranged in the interior space. As schematically shown in FIGS. 3, 5 and 10, each respective ring body 211, 221, 311, 321 encloses the interior space in a tight manner in the sense of the present invention. The interior space is not specifically identified with any reference numerals in the figures.

The measuring units 21, 22, 31, 32 operate according to the piezoelectric measuring principle and are configured and disposed to generate an electrical charge as a measuring signal under the effect of force and/or torque. The electrical charge provides an analog signal that is generated on surfaces of the piezoelectric material and tapped by electrodes arranged on the surfaces of the piezoelectric material. The quantity of electrical charge generated is proportional to the magnitude of the force and/or torque. Under the effect of the force and/or torque, the piezoelectric material generates electrical charge with a first sign and a second sign, which signs differ from each other as polar opposites. Therefore, each measuring unit 21, 22, 31, 32 for measuring force and/or torque comprises two surfaces of the piezoelectric material and each of two electrodes arranged on one of these two surfaces of the piezoelectric material. Thus, the two surfaces that are tapped on the piezoelectric material comprise a first surface and a second surface. The electrodes comprise a first electrode and a second electrode. On the first surface, electrical charge with the first sign is generated and tapped by the first electrode. On the second surface, electrical charge with the second sign is generated and tapped by the second electrode.

### The Electrical Conductors 23, 24, 33, 34

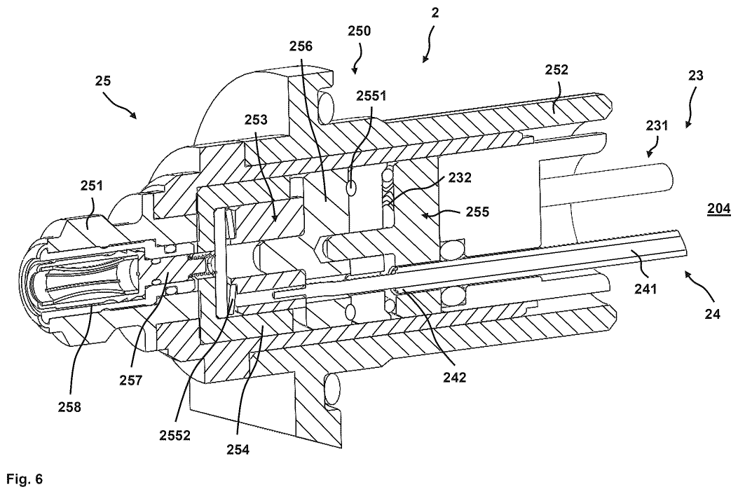

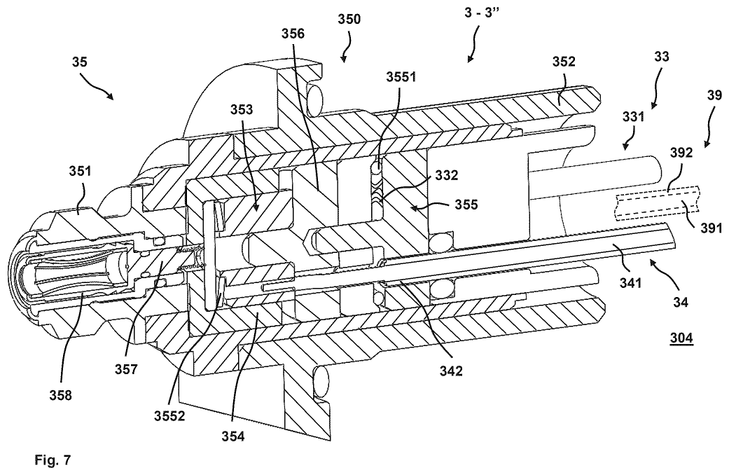

As schematically shown in FIGS. 3 and 5 for example, each transducer unit 2, 3-3″ comprises a plurality of electrical conductors 23, 24, 33, 34 and a respective feedthrough 25, 35, which is shown respectively in FIGS. 6 and 7. The electrical conductors 23, 24, 33, 34 are configured to perform the function of conducting the electrical charge from the measuring units 21, 22, 31, 32 to the feedthrough 25, 35.

As schematically shown in FIGS. 3 and 5 for example, the electrical conductors 23, 24, 33, 34 are arranged in the recesses 204, 304 that form the interior spaces of the respective base plates 202, 302, 402. According to the top view of FIG. 3 and FIG. 6's view partially perspective and partially in cross-section, the dual summing transducer unit 2 comprises two electrical conductors 23, 24, which identify as a left electrical conductor 23 and a right electrical conductor 24. According to the top view shown in FIG. 5 and FIG. 7's view partially perspective and partially in cross-section, the triple summing transducer unit 3-3″ comprises two electrical conductors 33, 34, which identify as a left electrical conductor 33 and a right electrical conductor 34.

The partially perspective views in FIGS. 6 and 7 show details of the electrical conductors 23, 24, 33, 34. Each electrical conductor 23, 24, 33, 34 comprises at least one NTC thermistor 231, 241, 331, 341 and at least one PTC thermistor 232, 242, 332, 342. Each NTC thermistor 231, 241, 331, 341 is a resistor with a negative temperature coefficient, which means that the electrical resistance of the resistor decreases as the temperature increases. Each PTC thermistor 232, 242, 332, 342 is a resistor with a positive temperature coefficient, which means that the electrical resistance of the resistor increases as the temperature increases.

According to the view of the dual summing transducer unit 2 shown in FIG. 6, the left electrical conductor 23 comprises a left NTC thermistor 231 and a left PTC thermistor 232, and the right electrical conductor 24 comprises a right NTC thermistor 241 and a right PTC thermistor 242. According to the view of the triple summing transducer unit 3-3″ shown in FIG. 7, the left electrical conductor 33 comprises a left NTC thermistor 331 and a left PTC thermistor 332, and the right electrical conductor 34 comprises a right NTC thermistor 341 and a right PTC thermistor 342.

Preferably, said electrical conductors 23, 24, 33, 34 are coaxial conductors with the NTC thermistors 231, 241, 331, 341 as the core and the PTC thermistors 232, 242, 332, 342 as the outer conductor. The NTC thermistors 231, 241, 331, 341 and the PTC thermistors 232, 242, 332, 342 are made of electrically conductive material. In each electrical conductor 23, 24, 33, 34, the NTC thermistors 231, 241, 331, 341 and the PTC thermistors 232, 242, 332, 342 are radially separated from each other by means of an electrical conductor insulation. The electrical conductor insulation is made of electrically insulating material. The electrical conductor insulation electrically insulates the NTC thermistor 231, 241, 331, 341 with respect to the PTC thermistor 232, 242, 332, 342. Preferably, each electrical conductor 23, 24, 33, 34 comprises a NTC thermistor 231, 241, 331, 341 and a PTC thermistor 232, 242, 332, 342 for each measured component of force and/or torque.

The electrical conductors 23, 24, 33, 34 define a first end and a second end. As schematically shown in FIGS. 3 and 5, each electrical conductor 23, 24, 33, 34 includes a connecting sleeve 233, 243, 333, 343, which desirably is formed as a hollow cylinder. The connecting sleeve 233, 243, 333, 343 desirably is made of mechanically resistant material such as stainless steel.

According to the top view of the dual summing transducer unit 2 in FIG. 3, a left connecting sleeve 233 is attached to the first end of the left electrical conductor 23, and a right connecting sleeve 243 is attached to the first end of the right electrical conductor 24. According to the top view of the triple summing transducer unit 3-3″ in FIG. 5, a left connecting sleeve 333 is attached to the first end of the left electrical conductor 33, and a right connecting sleeve 343 is attached to the first end of the right electrical conductor 34.

The connecting sleeve 233, 243, 333, 343 radially encloses the first end of the electrical conductor 23, 24, 33, 34 on the outside. The connecting sleeve 233, 243, 333, 343 forms a connection with the ring body of the measuring unit 21, 22, 33, 34. Preferably, the connection is a force-fit and form-fit connection such as a plug connection. However, with knowledge of the present invention, a person skilled in the art can also implement the connection as another force-fitting and form-fitting connection, such as a screw connection that is selectively detachable, and the like, or as a firmly bonded connection, such as a soldered connection and the like. In each implementation, the connection is tight in the sense of the present invention.

In the region of the connection between connecting sleeve 233, 243, 333, 343 and ring body of measuring unit 21, 22, 33, 34, said ring body defines a through hole. Said through hole extends from the outside of the measuring unit 21, 22, 33, 34 to the interior of the measuring unit 21, 22, 33, 34. The NTC thermistor 231, 241, 331, 341 and the PTC thermistor 232, 242, 332, 342 of the first end of an electrical conductor 23, 24, 33, 34 protrude via the through hole to the electrodes in the interior of the measuring unit 21, 22, 33, 34. The NTC thermistor 231, 241, 331, 341 is electrically connected to the first electrode. The PTC thermistor 232, 242, 332, 342 is electrically connected to the second electrode.

Each of the two electrical conductors 23, 24, 33, 34 is electrically connected to one of the two measuring units 21, 22, 31, 32 and the NTC thermistor summing element 253, 353, which are schematically shown in FIGS. 6 and 7. According to the top view of the dual summing transducer unit 2 in FIG. 3, the left NTC thermistor 231 from the left measuring unit 21 conducts electrical charge with the first sign, and the left PTC thermistor 232 from the left measuring unit 21 conducts electrical charge with the second sign. The right NTC thermistor 241 conducts electrical charge with the first sign from the right measuring unit 22. The right PTC thermistor 242 conducts electrical charge with the second sign from the right measuring unit 22. According to the top view of the triple summing transducer unit 3-3″ shown in FIG. 5, the left NTC thermistor 331 conducts electrical charge with the first sign from the left measuring unit 31, and the left PTC thermistor 332 conducts electrical charge with the second sign from the left measuring unit 31. The right NTC thermistor 341 conducts electrical charge with the first sign from the right measuring unit 32. The right PTC thermistor 342 conducts electrical charge with the second sign from the right measuring unit 32.

### The Feedthrough 25, 35

Each of the feedthroughs 25, 35 is configured to perform the function of conducting electrical charge from the housing 20, 30 to the outside of the housing 20, 30.

According to FIGS. 2 and 3, the dual summing transducer unit 2 comprises a feedthrough 25 which is attached to the housing 20. According to FIGS. 4 and 5, the triple summing transducer unit 3-3″ comprises a feedthrough 35 which is attached to the housing 30.

Preferably, said feedthrough 25, 35 is attached to the base plate 202, 302 of the housing 20, 30. In the region where the feedthrough 25, 35 is attached to the base plate 202, 302, said base plate 202, 302 defines a passage opening. The passage opening of the base plate 202, 302 extends from the outside of the housing 20, 30 to the recess 204, 304 defined within the housing 20, 30.

The view shown in FIG. 6 depicts details of the feedthrough 25 of the dual summing transducer unit 2, and the view in FIG. 7 shows details of the feedthrough 35 of the triple summing transducer unit 3-3″.

The respective feedthrough 25, 35 comprises a respective flange 250, 350. The flange 250, 350 is made of mechanically resistant material such as stainless steel. The feedthrough 25, 35 is mounted in the passage opening of the base plate 202, 302 via said flange 250, 350. The attachment of the feedthrough 25, 35 to the base plate 202, 302 is preferably a force-and form-fitting connection such as a screw connection. The attachment of the feedthrough 25, 35 to the base plate 202, 302 is tight in the sense of the present invention. With knowledge of the present invention, a person skilled in the art can also realize the attachment of the feedthrough to the base plate as a firmly bonded connection, such as a welded connection and the like.

Said feedthrough 25, 35 is designed to conduct the electrical charge to the outside of the housing 20, 30. According to the view shown in FIG. 6, the dual summing transducer unit 2 comprises a flange 250 for this purpose, which has a left end 251 directed away from the recess 204 in the direction of elongation and a right end 252 directed towards the recess 204 in the direction of elongation. According to the view shown in FIG. 7, the triple summing transducer unit 3-3″ also comprises a flange 350, which has a left end 351 directed along the elongation direction away from the recess 304 and a right end 352 directed along the elongation direction towards the recess 304. The left end 251, 351 is bushing-shaped and encloses a left cavity of the feedthrough 25, 35. The right end 252, 352 is hollow cylindrical and encloses a right cavity of the feedthrough 25, 35.

As schematically shown in FIGS. 6 and 7, the feedthrough 25, 35 comprises a NTC thermistor summing element 253, 353, a NTC thermistor insulation element 254, 354, a PTC thermistor summing element 255, 355, and a PTC thermistor insulation element 256, 356. The NTC thermistor summing element 253, 353 and the PTC thermistor summing element 255, 355 are made of electrically conductive material. The NTC thermistor insulation element 254, 354 and the PTC thermistor insulation element 256, 356 are made of electrically insulating material.

According to the view shown in FIG. 6, the dual summing transducer unit 2 comprises a NTC thermistor summing element 253, a NTC thermistor insulation element 254, a PTC thermistor summing element 255, and a PTC thermistor insulation element 256, which are arranged in the right cavity of the right end 252. According to the view shown in FIG. 7, the triple summing transducer unit 3-3″ comprises a NTC thermistor summing element 353, an electrical NTC thermistor insulation element 354, a PTC thermistor summing element 355, and an electrical PTC thermistor insulation element 356, which are arranged in the right cavity of the right end 352.

Said NTC thermistor insulation element 254, 354 electrically insulates the NTC thermistor summing element 253, 353 in the direction of elongation in the views in FIGS. 6 and 7 with respect to the right end 252, 352.

Said PTC thermistor insulation element 256, 356 electrically insulates the NTC thermistor summing element 253, 353 in elongation direction of the views in FIGS. 6 and 7 with respect to the PTC thermistor summing element 255, 355.

Said NTC thermistors 231, 241, 331, 341 and said PTC thermistors 232, 242, 332, 342 of the second end of the electrical conductors 23, 24, 33, 34 protrude into the right cavity of the right end 252, 352.

Said NTC thermistors 231, 241, 331, 341 of the second end of the electrical conductors 23, 24, 33, 34 are electrically connected to the NTC thermistor summing element 253, 353. The left NTC thermistors 231, 331 conduct electrical charge with the first sign from the left measuring unit 21, 31 to the NTC thermistor summing element 253, 353. The right NTC thermistors 241, 341 conduct electrical charge with the first sign from the right measuring unit 22, 32 to the NTC thermistor summing element 253, 353.

The electrical connection between the NTC thermistors 231, 241, 331, 341 and the NTC thermistor summing element 253, 353 is preferably a force-fit and form-fit connection such as a clamp connection, a screw connection and the like, or a firmly bonded connection such as a soldered connection and the like.

The PTC thermistors 232, 242, 332, 342 at the second end of the electrical conductors 23, 24, 33, 34 are electrically connected to the PTC thermistor summing element 255, 355. The left PTC thermistors 232, 332 are configured to conduct electrical charge with the second sign from the left measuring unit 21, 31 to the PTC thermistor summing element 255, 355. The right PTC thermistors 242, 342 are configured to conduct electrical charge with the second sign from the right measuring unit 22, 32 to the PTC thermistor summing element 255, 355.

Preferably, said PTC summing element 255, 355 is connected to a ground potential of said measuring wheel 1. The ground potential is an electrical reference potential such as 0 V.

Preferably, the electrical connection of the PTC thermistors 232, 242, 332, 342 to the PTC thermistor summing element 255, 355 is a force-fit and form-fit connection such as a clamp connection, a screw connection and the like, or a firmly bonded connection such as a soldered connection and the like. Preferably, the electrical connection of the PTC thermistors 232, 242, 332, 342 to the PTC thermistor summing element 255, 355 is a clamp connection. For this purpose, the feedthrough 25, 35 comprises a ring element 2551, 3551 and a spring element 2552, 3552 made of electrically conductive material as schematically shown in FIGS. 6 and 7.

According to the view of the dual summing transducer unit 2 shown in FIG. 6, said feedthrough 25 comprises a ring element 2551 and a spring element 2552 that is configured and disposed to exert a biasing force in a biasing direction against the ring element 2551. According to the view of the triple summing transducer unit 3-3″ shown in FIG. 7, said feedthrough 35 comprises a ring element 3551 and a spring element 3552 that is configured and disposed to exert a biasing force against the ring element 3551.

Said PTC thermistor 232, 242, 332, 342 consists of individual wires which, according to the views shown in FIGS. 6 and 7, are arranged in a plane shown therein between the PTC thermistor summing element 255, 355 and the ring element 2551, 3551. The spring element 2552, 3552 is configured and disposed to press the ring element 2551, 3551 in the biasing direction with a force against the PTC thermistor summing element 255, 355 and thus to electrically connect the PTC thermistors 232, 242, 332, 342 to the PTC thermistor summing element 255, 355.

As shown in FIGS. 6 and 7, said feedthrough 25, 35 comprises an electrical contact element 257, 357 made of electrically conductive material and an insulation element 258, 358 made of electrically insulating material.

According to the view shown in FIG. 6, the dual summing transducer unit 2 comprises an electrical contact element 257 and an insulation element 258, which are arranged in the left cavity of the left end 251. According to the view shown in FIG. 7, the triple summing transducer unit 3-3″ comprises an electrical contact element 357 and an insulation element 358, which are arranged in the left cavity of the left end 351.

The insulating element 258, 358 electrically insulates the electrical contact element 257, 357 in the elongation direction of the views of the respective feedthrough 25, 35 shown in FIGS. 6 and 7 with respect to the left end 251, 351.

The left cavity of the left end 251, 351 and the right cavity of the right end 252, 352 communicate with each other in regions in the elongation direction of the views of the respective feedthrough 25, 35 shown in FIGS. 6 and 7. The electrical contact element 257, 357 is electrically connected to the thermistor summing element 253, 353 via this communication. The respective electrical contact element 257, 357 is electrically insulated with respect to the left end 251, 351 and the right end 252, 352 in the region of this communication by the respective NTC thermistor insulation element 254, 354 and the insulation element 258, 358.

### The Additional Feedthrough 36

Said dual summing transducer unit 2 and said triple summing transducer units 3-3″ differ in that the triple summing transducer unit 3-3″ comprises an additional feedthrough 36 and an additional electrical conductor 39, while the dual summing transducer unit 2 omits an additional feedthrough and additional electrical conductor.

The additional feedthrough 36 is configured to perform the function of conducting additional electrical charge from the outside of the housing 30 into the housing 30.

According to FIGS. 4 and 5, the triple summing transducer unit 3-3″ comprises an additional feedthrough 36, which is attached to the housing 30.

Preferably, the additional feedthrough 36 is attached to the base plate 302 of the housing 30. In the region where the additional feedthrough 36 is attached to the base plate 302, said base plate 302 defines an additional passage opening. The additional passage opening of the base plate 302 extends from the outside of the housing 30 to the recess 304 in the housing 30.

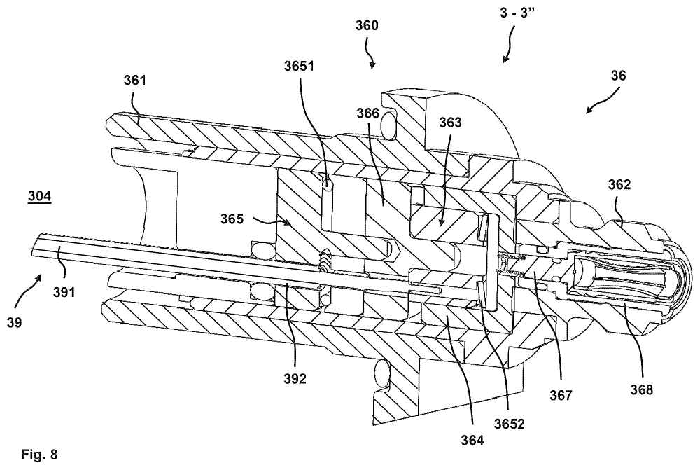

The perspective view of the triple summing transducer unit 3-3″ shown in FIG. 8 depicts details of the additional feedthrough 36. The additional feedthrough 36 comprises an additional flange 360. The additional flange 360 is made of mechanically resistant material such as stainless steel. The additional feedthrough 36 is mounted in the additional passage opening of the base plate 302 via said additional flange 360.

The attachment of the additional feedthrough 36 to the base plate 302 is preferably a firmly bonded connection such as a welded joint and the like. The attachment of the additional feedthrough 36 to the base plate 302 is tight in the sense of the present invention.

Said additional feedthrough 36 is configured and disposed to conduct the additional electrical charge from the outside of the housing 30 into the housing 30. According to the view shown in FIG. 8, the triple summing transducer unit 3-3″ for this purpose comprises an additional flange 360, that defines a left additional end 361 directed along the elongation direction of the additional feedthrough 36 towards the recess 304 and a right additional end 362 directed away from the recess 304. The left additional end 361 is configured as hollow and cylindrical and configured to enclose a left additional cavity of the additional feedthrough 36. The right additional end 362 is configured as bushing-shaped and configured to enclose a right additional cavity of the additional feedthrough 36.

As depicted in FIG. 8, said additional feedthrough 36 comprises a NTC thermistor contact element 363, an additional NTC thermistor insulation element 364, a PTC thermistor contact element 365, and an additional PTC thermistor insulation element 366. The NTC thermistor contact element 363 and the PTC thermistor contact element 365 are made of electrically conductive material. The additional NTC thermistor insulation element 364 and the additional PTC thermistor insulation element 366 are made of electrically insulating material.

According to the view shown in FIG. 8, said triple summing transducer unit 3-3″ comprises a NTC thermistor contact element 363, an additional NTC thermistor insulation element 364, a PTC thermistor contact element 365, and an additional PTC thermistor insulation element 366, which are arranged in the left additional cavity of the left additional end 361.

The additional NTC thermistor insulation element 364 electrically insulates the NTC thermistor contact element 363 in the direction of elongation of the additional feedthrough 36 in the view shown in FIG. 8 with respect to the left additional end 361. The additional PTC thermistor insulation element 366 electrically insulates the PTC thermistor contact element 363 in the elongation direction of the view shown in FIG. 8 with respect to the PTC thermistor contact element 365.

### The Additional Electrical Conductor 39

The additional electrical conductor 39 is configured to perform the function of conducting additional electrical charge from the additional feedthrough 36 to the feedthrough 35.

The views of the triple summing transducer unit 3-3″ shown in FIGS. 7 and 8 depict details of the additional electrical conductor 39. The additional electrical conductor 39 is arranged in the recess 304. Each additional electrical conductor 39 comprises at least one additional NTC thermistor 391 and at least one additional PTC thermistor 392.

Preferably, as schematically shown in FIG. 8, the additional electrical conductor 39 is a coaxial conductor with the additional NTC thermistor 391 as the core and the additional PTC thermistor 392 as the outer conductor. Said additional NTC thermistor 391 and the additional PTC thermistor 392 are made of electrically conductive material. In the additional electrical conductor 39, the additional NTC thermistor 391 and the additional PTC thermistor 392 are radially separated from each other by an additional electrical conductor insulation, which is schematically indicated by the parallel dashed lines depicted in FIG. 7. The additional electrical conductor insulation is made of electrically insulating material. The additional electrical conductor insulation electrically insulates the additional NTC thermistor 391 with respect to the additional PTC thermistor 392. Preferably, the additional electrical conductor 39 comprises an additional NTC thermistor 391 and an additional PTC thermistor 392 for each measured component of force and/or torque.

The additional electrical conductor 39 defines a first end and a second end disposed opposite the first end in direction in which the additional electrical conductor elongates as shown in FIG. 8.

The additional NTC thermistor 391 and the additional PTC thermistor 392 of the first end of the additional electrical conductor 39 protrude into the left additional cavity of the left additional end 361.

As shown in FIG. 8, the additional NTC thermistor 391 of the first end of the additional electrical conductor 39 is configured to be received into and electrically connected to the NTC thermistor contact element 363 of the additional feedthrough 36.

The electrical connection between the additional NTC thermistor 391 and the NTC thermistor contact element 363 is preferably a force-fit and form-fit connection such as a clamp connection, a screw connection and the like, or a firmly bonded connection such as a soldered connection and the like.

As shown in FIG. 8, the additional PTC thermistor 392 of the first end of the additional electrical conductor 39 is configured to be received into and electrically connected to the PTC thermistor contact element 365 of the additional feedthrough 36.

Preferably, the PTC thermistor contact element 365 is connected to a ground potential of the measuring wheel 1. The ground potential is an electrical reference potential such as 0 V.

The electrical connection between the additional PTC thermistor 392 and the PTC thermistor contact element 365 is preferably a force-fit and form-fit connection such as a clamp connection, a screw connection and the like, or a firmly bonded connection such as a soldered connection and the like. According to the view shown in FIG. 8, the electrical connection of the additional PTC thermistor 392 to the PTC thermistor contact element 365 is a clamp connection. For this purpose, the additional feedthrough 36 comprises an additional ring element 3651 and an additional spring element 3652 made of electrically conductive material.

The additional PTC thermistor 392 consists of individual wires which, according to the view shown in FIG. 8, are arranged in the plane facing the viewer of FIG. 8 and disposed between the PTC thermistor contact element 365 and the additional ring element 3651. According to the view shown in FIG. 8, the additional spring element 3652 is designed to press the additional ring element 3651 in elongation direction with a biasing force against the PTC contact element 365, thereby electrically connecting the additional PTC 392 thermistor to the PTC thermistor contact element 365.

According to the view of the triple summing transducer unit 3-3″ shown in FIG. 8, the additional NTC thermistor 391 is configured to conduct additional electrical charge with the first sign from the NTC thermistor contact element 363 of the additional feedthrough 36. The additional PTC thermistor 392 is configured to conduct additional electrical charge with the second sign from the PTC thermistor contact element 365 of the additional feedthrough 36.

According to the view of the triple summing transducer unit 3-3″ shown in FIG. 7, the additional NTC thermistor 391 and the additional PTC thermistor 392 of the second end of the additional electrical conductor 39 protrude into the right cavity of the right end 352.

The additional NTC thermistor 391 of the second end of the additional electrical conductor 39 is electrically connected to the NTC thermistor summing element 353 of the feedthrough 35 of the triple summing transducer unit 3-3″. The additional NTC thermistor 391 is configured to conduct additional electrical charge with the first sign to the NTC thermistor summing element 353 of the feedthrough 35.

The electrical connection between the additional NTC thermistor 391 and the NTC thermistor summing element 353 of the triple summing transducer unit 3-3″ is preferably a force-fit and form-fit connection such as a clamp connection, a screw connection and the like, or a firmly bonded connection such as a soldered connection and the like.

The additional PTC thermistor 392 of the second end of the additional electrical conductor 39 is electrically connected to the PTC thermistor summing element 355 of the feedthrough 35 of the triple summing transducer unit 3-3″. The additional PTC thermistor 392 is configured to conduct additional electrical charge with the second sign to the PTC thermistor summing element 355 of the feedthrough 35.

The electrical connection between the additional PTC thermistor 392 and the PTC thermistor summing element 355 is preferably a force-fit and form-fit connection such as a clamp connection, a screw connection and the like, or a firmly bonded connection such as a soldered connection and the like. According to the view shown in FIG. 7, the electrical connection between the additional PTC thermistor 392 and the PTC thermistor summing element 355 is a clamp connection.

The additional PTC thermistor 392 consists of individual wires which, according to the view of the triple summing transducer unit 3-3″ shown in FIG. 7, are arranged in the plane of elongation between the PTC thermistor summing element 355 and the ring element 3551. According to the view shown in FIG. 7, the spring element 3552 is configured and disposed to press said ring element 3551 in the elongation direction with a force against the PTC summing element 355, thereby electrically connecting the additional PTC thermistor 392 to the PTC summing element 355.

According to the view of the triple summing transducer unit 3-3″ shown in FIG. 8, the additional feedthrough 36 comprises an additional electrical contact element 367 made of electrically conductive material and an additional insulation element 368 made of electrically insulating material. The additional electrical contact element 367 and the additional insulation element 368 are arranged in the right additional cavity of the right additional end 362.

The additional insulating element 368 electrically insulates the additional electrical contact element 367 in the elongation direction of the view shown in FIG. 8 with respect to the right additional end 362.

The left additional cavity of the left additional end 361 and the right additional cavity of the right additional end 362 communicate with each other in the elongation direction of the view shown in FIG. 8. The additional electrical contact element 367 is electrically connected to the NTC thermistor contact element 363 via this communication. The additional electrical contact element 367 is electrically insulated with respect to the left additional end 361 and the right additional end 362 in the area of this communication by the additional NTC thermistor insulation element 364 and the additional insulation element 368.

Thus, in the dual summing transducer unit 2, two NTC thermistors 231, 241 are configured to conduct electrical charge with the first sign from the two measuring units 21, 22 to the NTC thermistor summing element 253 of the feedthrough 25. This means that dual summing of the incoming charges with the first sign takes place. In the triple summing transducer unit 3-3″, on the other hand, two NTC thermistors 331, 341 are configured to conduct electrical charge with the first sign from the two measuring units 31, 32 to the NTC thermistor summing element 353 of the feedthrough 35, and the additional NTC thermistor 391 additionally is configured and disposed to conduct additional electrical charge with the first sign from the additional feedthrough 36 to the NTC thermistor summing element 353 of the feedthrough 35. Thus, a triple summation of the incoming charges with the first sign takes place.

And in the dual summing transducer unit 2, two PTC thermistors 232, 242 are configured to conduct electrical charge with the second sign from the two measuring units 21, 22 to the PTC thermistor summing element 255 of the feedthrough 25. Thus, dual summing of the incoming charges with the second sign takes place. While in the triple summing transducer unit 3-3″, two PTC thermistors 332, 342 are configured to conduct electrical charge with the second sign from the two measuring units 31, 32 to the PTC summing element 355 of the feedthrough 35, and the additional PTC thermistor 392 from the additional feedthrough 36 additionally is configured to conduct additional electrical charge with the second sign to the PTC thermistor summing element 355 of the feedthrough 35. Thus, triple summation of the incoming charges with the second sign takes place.

With knowledge of the present invention, the person skilled in the art is likewise informed how to use a triple summing transducer unit 3-3″ according to FIGS. 4, 5, 7, and 8 in the measuring wheel 1 according to FIG. 1 instead of the dual summing transducer unit 2 according to FIGS. 2, 3, and 6. Since only a dual summation is performed with the dual summing transducer unit 2 in the measuring wheel 1 according to FIG. 1, the additional NTC thermistor 391 and the additional PTC thermistor 392 of the feedthrough 35 according to the view of FIG. 7 are not used in this implementation of the present invention. The additional feedthrough 36 and the additional electrical line 39 according to FIGS. 4, 5, and 8 are also not used in this implementation of the present invention. However, this adaptability of interchangeable parts results in an economic advantage in terms of identical parts, since both the dual summing transducer unit 2 and the triple summing transducer unit 3-3″ in the measuring wheel 1 according to FIG. 1 are then constructed in the same way. This adaptability reduces the variety of transducer units to one common part, which lowers manufacturing costs.

Furthermore, with knowledge of the present invention, the person skilled in the art is informed how to use a feedthrough 35 according to FIGS. 4, 5, and 7 of the triple summing transducer unit 3-3″ in the dual summing transducer unit 2 instead of the feedthrough 25 according to FIGS. 2, 3, and 6. Since only a dual summation is performed with the dual summing transducer unit 2 in the measuring wheel 1 according to FIG. 1, the additional NTC thermistor 391 and the additional PTC thermistor 392 of the feedthrough 35 according to the view of FIG. 7 are not used in this dual implementation. This degree of adaptability also results in an economic advantage in terms of common parts that are interchangeable between the dual and triple implementations, since in the measuring wheel 1 according to FIG. 1, both the dual summing transducer unit 2 and the triple summing transducer unit 3-3″ comprise the same feedthrough 35, which reduces the variety of feedthroughs and lowers manufacturing costs.

### The Electronic Circuit 4

As schematically shown in FIGS. 1, 9, 11 and 12, the measuring wheel 1 comprises an electronic circuit 4. The electronic circuit 4 is configured to perform the function of evaluating the electrical charge collected by the measuring units 21, 31, 22, 32.

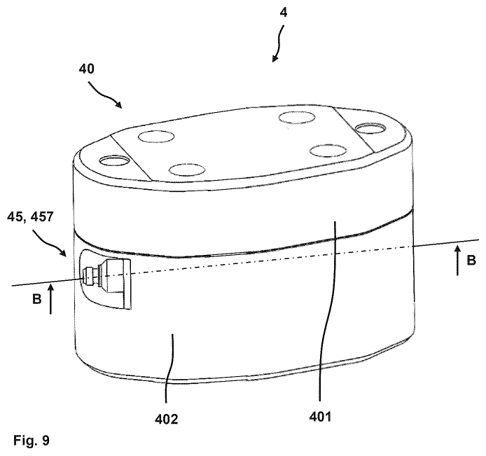

As schematically shown in FIGS. 9, 11 and 12, said electronic circuit 4 comprises a housing 40. The housing 40 is configured and disposed to perform the function of protecting the electronic components of the electronic circuit 4 from harmful environmental influences such as dust, moisture, direct contact and the like.

The housing 40 of the electronic circuit 4 is made of mechanically resistant material such as stainless steel. Preferably, said housing 40 consists of multiple parts. The housing 40 comprises a cover plate 401 and a base plate 402. The cover plate 401 and the base plate 402 are connected conventionally to each other by connecting means such as screws or bolts. The connecting means are not shown in the figure. The connection between the cover plate 401 and the base plate 402 is tight in the sense of the present invention.

The housing 40 of the electronic circuit 4 comprises a plurality of fastening means. Said housing 40 is designed to be fastened to the measuring wheel 1 via said fastening means, which conventionally can include components such as screws or bolts. The fastening means are not shown in the figure.

The electronic circuit 4 comprises a feedthrough 45. Said feedthrough 45 is configured to perform the function of conducting electrical charge from the outside of the housing 40 into the housing 40.

According to FIG. 9, said feedthrough 45 of the electronic circuit 4 is attached to the housing 40.

Preferably, said feedthrough 45 is attached to the base plate 402 of the housing 40 of the electronic circuit 4. In the region where the feedthrough 45 is attached to the base plate 402, said base plate 402 defines a passage opening. The passage opening of the base plate 402 extends from the outside of the housing 40 into the housing 40.

According to the view shown in FIGS. 9, 11 and 12, the feedthrough 45 of the electronic circuit 4 comprises an electrical contact element 457 and an electrical insulation element 458.

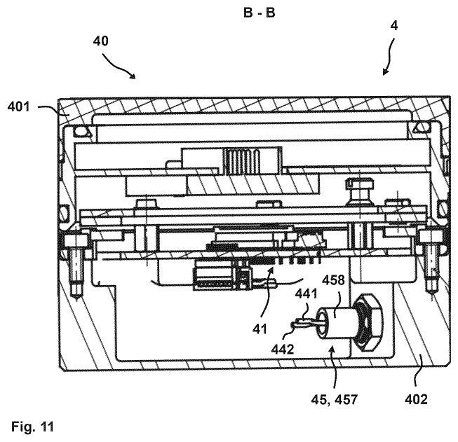

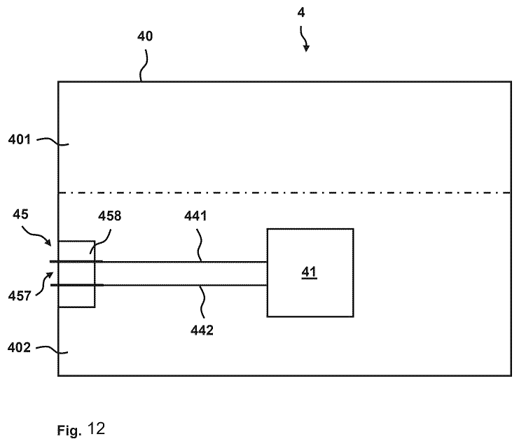

The electrical insulation element 458 shown schematically in FIGS. 11 and 12 is configured and disposed to electrically insulate the electrical contact element 457 in the view in FIG. 9 with respect to the housing 40.

The electronic circuit 4 is designed to evaluate the electrical charge collected by the measuring units 21, 31, 22, 32. The evaluation of the electrical charge comprises components that are configured to perform electrical amplification of the electrical charge, conversion of the electrical charge into an electrical voltage, digitization of the electrical voltage into measurement data, radio transmission of the measurement data and the like. For this purpose, said electronic circuit 4 comprises multiple electronic components indicated generally by the numeral 41 in FIG. 11. The NTC thermistor 441 and PTC thermistor 442 are schematically shown in FIGS. 11 and 12 in relation to the electronic components 41. However, because such electronic components 41 are conventional in the electronic arts, none is identified individually or in relation to each other in these figures, nor discussed in further detail.

### The Signal Cables 5-5″′

As schematically shown in FIG. 1, the measuring wheel 1 comprises a plurality of signal cables 5-5″′. Said signal cables 5-5″′ are configured and disposed to perform the function of electrically conducting the electrical charge and the additional electrical charge from the transducer units 2, 3-3″ to the electronic circuit 4.

Each signal cable 5-5″′ comprises at least one NTC signal thermistor and at least one PTC signal thermistor. The signal cables 5-5″′ are constructed in an identical manner. The NTC signal thermistors and the PTC signal thermistors are not shown in FIG. 1.

According to the view shown in FIG. 1, said signal cables 5-5″′ comprise a first signal cable 5, a second signal cable 5′, a third signal cable 5″, and a fourth signal cable 5″′.

Preferably, the signal cables 5-5″′ are coaxial cables with the NTC signal thermistors as the core and the PTC signal thermistors as the outer conductor configured like NTC thermistor 391 and PTC thermistor 392 depicted schematically in FIG. 7 for example. The NTC signal thermistors and the PTC signal thermistors are made of electrically conductive material. In each signal cable 5-5″, the NTC signal thermistor and the PTC signal thermistor are radially separated from each other by electrical cable insulation, which is schematically indicated by the parallel dashed lines depicted in FIG. 7. The electrical cable insulation is made of electrically insulating material. The electrical cable insulation electrically insulates the NTC signal thermistor with respect to the PTC signal thermistor. Preferably, each signal cable 5-5″′ comprises a NTC signal thermistor and a PTC signal thermistor for each measured component of force and/or torque.

According to the view shown in FIG. 1, each signal cable 5-5″′ comprises at one opposite end thereof a first cable end 55-55″′ and a second cable end 56-56″′ disposed at the opposite end of each signal cable from the first cable end. The first cable ends 55-55″′ and the second cable ends 56-56″′ desirably are designed as plugs. Each plug is designed to form a force-fit and form-fit connection, such as a plug connection, with the feedthrough 25, 35 of the transducer unit 2, 3-3″ or with the additional feedthrough 36 of the transducer unit 3-3″ or with the feedthrough 45 of the electronic circuit 4. The plug connection is a mechanical connection with the feedthrough 25, 35 of the transducer unit 2, 3-3″ or with the additional feedthrough 36 of the transducer unit 3-3″ or with the feedthrough 45 of the electronic circuit 4. The plug connection is an electrical connection with the electrical contact element 257, 357 of the feedthrough 25, 35 of the transducer unit 2, 3-3″ or with the additional electrical contact element 367 of the additional feedthrough 36 of the transducer unit 3-3″ or with the electrical contact element 457 of said feedthrough 45 of the electronic circuit 4. The plug connection is configured to be selectively detachable by manual dexterity. The plug connection is tight in the sense of the present invention.

According to the view shown in FIG. 1, the first signal cable 5 is connected with its first cable end 55 to the feedthrough 25 of the dual summing transducer unit 2, and the NTC signal thermistor of the first cable end 55 contacts the electrical contact element 257 of the feedthrough 25 and thus is configured to conduct electrical charge with the first sign of the dual summing transducer unit 2. With its second cable end 56, the first signal cable 5 is connected to the additional feedthrough 36 of the first triple summing transducer unit 3, and the NTC signal thermistor of the second cable end 56 contacts the additional electrical contact element 367 of the additional feedthrough 36 and thus is configured to conduct electrical charge with the first sign of the dual summing transducer unit 2 as additional electrical charge with the first sign to the triple summing transducer unit 3.

According to the view shown in FIG. 1, the second signal cable 5′ is connected with its first cable end 55′ to the feedthrough 35 of the first triple summing transducer unit 3, and the NTC signal thermistor of the first cable end 55′contacts the electrical contact element 357 of the feedthrough 35 and thus is configured to conduct electrical charge with the first sign of the first triple summing transducer unit 3. The second signal cable 5′ is connected with its second cable end 56′ to the additional feedthrough 36 of the second triple summing transducer unit 3′, and the NTC signal thermistor of the second cable end 56′contacts the additional electrical contact element 367 of the additional feedthrough 36 and thus is configured to conduct electrical charge with the first sign of the first triple summing transducer unit 3 as additional electrical charge with the first sign to the second triple summing transducer unit 3′.

According to the view shown in FIG. 1, the third signal cable 5″ is connected with its first cable end 55″ to the feedthrough 35 of the second triple summing transducer unit 3′, and the NTC signal thermistor of the first cable end 55″ contacts the electrical contact element 357 of the feedthrough 35 and thus is configured to conduct electrical charge with the first sign of the second triple summing transducer unit 3′. With its second cable end 56″, the third signal cable 5″ is connected to the additional feedthrough 36 of the third triple summing transducer unit 3″ and the NTC signal thermistor of the second cable end 56″ contacts the additional electrical contact element 367 of the additional feedthrough 36 and thus is configured to conduct electrical charge with the first sign of the second triple summing transducer unit 3′ as additional electrical charge with the first sign to the third triple summing transducer unit 3″.

According to the view shown in FIG. 1, the fourth signal cable 5″′ is connected with its first cable end 55″′ to the feedthrough 35 of the third triple summing transducer unit 3″, and the NTC signal thermistor of the first cable end 55″′ contacts the electrical contact element 357 of the feedthrough 35 and thus is configured to conduct electrical charge with the first sign of the third triple summing transducer unit 3″. With its second cable end 56″, the fourth signal cable 5″′ is connected to the feedthrough 45 of the electronic circuit 4, and the NTC signal thermistor of the second cable end 56″′ contacts the electrical contact element 457 of the feedthrough 45 of the electronic circuit 4 and thus is configured to conduct electrical charge with the first sign of the third triple summing transducer unit 3″ as additional electrical charge with the first sign to the electronic circuit 4.

### LIST OF REFERENCE SYMBOLS

1 Measuring wheel
2 Dual summing transducer unit
3-3″ Triple summing transducer unit
4 Electronic circuit
5-5″′ Signal cable
6 Hub
7 Rim
8 Tire
20, 30, 40 Housing
21, 31 Left measuring unit
22, 32 Right measuring unit
23, 33 Left electrical conductor
24, 34 Right electrical conductor
25, 35, 45 Feedthrough
27, 37 Left preload unit
28, 38 Right preload unit
36 Additional feedthrough
39 Additional electrical conductor
55-55″′ Left cable end
56-56″′ Right cable end
201, 301, 401 Cover plate
202, 302, 402 Base plate
204, 304 Recess
205, 305 Left cover
206, 306 Right cover
211, 221 Ring body housing
212, 222, 312, 322 Piezoelectric material
213, 223, 313, 323 Electrodes
231, 331 Left NTC thermistor
232, 332 Left PTC thermistor
233, 333 Left connecting sleeve
241, 341, 441 Right NTC thermistor
242, 342, 442 Right PTC thermistor
243, 343 Left connecting sleeve
250, 350 Flange
251, 351 Left End
252, 352 Right End
253, 353 NTC thermistor summing element
254, 354 NTC thermistor insulation element
255, 355 PTC thermistor summing element
256, 356 PTC thermistor insulation element
257, 357, 457 Electrical contact element
258, 358, 458 Insulation element
271, 371 Left preload screw
272, 372 Left preload bore
281, 381 Right preload screw
282, 382 Right preload bore
360 Additional flange
361 Left additional end
362 Right additional end
363 NTC thermistor contact element
364 Additional NTC thermistor insulation element
365 PTC thermistor contact element
366 Additional PTC thermistor insulation element
367 Additional electrical contact element
368 Additional insulation element
391 Additional NTC thermistor
392 Additional PTC thermistor
2551, 3551 Ring element
2552, 3552 Spring element
3651 Additional ring element
3652 Additional spring element

What is claimed is:

1. A transducer unit for measuring at least one of a force and a torque on a wheel of a vehicle, the transducer unit comprising:
a housing that defines an inside and an outside;
a feedthrough attached to the housing and configured to conduct electrical charge from the inside to the outside of the housing;
a plurality of measuring units disposed in the inside of said housing and configured to generate an electrical charge under the effect of the at least one of the force and the torque;
a plurality of electrical conductors disposed in the inside of the housing and configured to conduct the electrical charge from the plurality of measuring units to the feedthrough;
an additional feedthrough attached to the housing and configured to conduct additional electrical charge from the outside of the housing into the inside of the housing; and
an additional electrical conductor disposed in the inside of the housing and configured to conduct the additional electrical charge from the additional feedthrough to the feedthrough.

2. The transducer unit according to claim 1,
wherein the plurality of measuring unit includes a first measuring unit and a second measuring unit;
wherein the plurality of electrical conductors includes a first electrical conductor electrically connected to the first measuring unit;
wherein the plurality of electrical conductors includes a second electrical conductor electrically connected to the second measuring unit;
wherein said feedthrough includes a NTC thermistor summing element; and
wherein each of the first electrical conductors and the second electrical conductor is electrically connected to the NTC thermistor summing element.

3. The transducer unit according to claim 2, wherein the additional electrical conductor is electrically connected to the NTC thermistor summing element, which is configured to sum electrical charge from the first and second measuring units and additional electrical charge from the additional feedthrough to function as a triple summing transducer unit.

4. The transducer unit according to claim 1, wherein the housing includes a cover plate and a base plate;
wherein the base plate defines a recess in which the first and second measuring units are disposed;
wherein the housing includes a plurality of covers;
wherein the cover plate defines a plurality of openings disposed directly above the first and second measuring units in the recess, and a respective one of each of the plurality of covers is disposed in a respective one of the plurality of openings defined in the cover plate; and
wherein each of the plurality of covers disposed in the plurality of openings of the cover plate is configured and disposed to transmit at least one of the force and torque to the first and second measuring units.

5. The transducer unit according to claim 4, further comprising:
a plurality of preload units, wherein each of the plurality of preload units includes a respective preload screw associated with a respective preload bore, which is defined in the base plate; and
wherein each respective preload screw defines a head portion that rests against the cover when screwed into each respective preload bore such that rotation of each respective preload screw in each respective preload bore permits mechanical preloading of the first and second measuring units.

6. The transducer unit according to claim 4, wherein each of the first and second measuring units defines an interior space and an outside and includes a ring body and a through hole, which extends from the outside of the measuring unit to the interior space of the measuring unit;
wherein each of the first and second measuring units includes piezoelectric material in the interior space, which piezoelectric material defines surfaces and is configured to generate an electric charge at said surfaces under the effect of at least one of the force and torque; and
wherein each of the first and second measuring units includes electrodes in the interior, which electrodes are arranged on the surfaces of the piezoelectric material and configured to tap the electrical charge.

7. The transducer unit according to claim 6, wherein the surfaces of the piezoelectric material include a first surface and a second surface, and the electrodes include a first electrode and a second electrode;
wherein the piezoelectric material is configured to generate an electric charge with a first sign under the effect of the at least one force and torque on the first surface, and the first electrode is configured to tap the electric charge with the first sign; and
wherein the piezoelectric material is configured to generate an electric charge with a second sign on the second surface under the effect of the at least one force and torque, and the second electrode is configured to tap the electric charge with the second sign.

8. The transducer unit according to claim 7, wherein the first and second electrical conductors are arranged in said recess;
wherein each of the first and second electrical conductors defines a first end and a second end;
wherein each of the first and second electrical conductors includes a NTC thermistor and a PTC thermistor;
wherein the first end of one of the first and second electrical conductors protrudes through the through hole to the first and second electrodes in the interior of the measuring unit and the NTC thermistor is electrically connected to the first electrode and the PTC thermistor is electrically connected to the second electrode.

9. The transducer unit according to claim 8,
wherein the feedthrough includes a NTC thermistor summing element and a PTC thermistor summing element;
wherein the NTC thermistors of the second ends of the electrical conductors are electrically connected to the NTC thermistor summing element; and
wherein each of the second ends of the electrical conductors includes a PTC thermistor and are electrically connected to the PTC thermistor summing element.

10. The transducer unit according to claim 9, wherein the feedthrough includes a ring element and a spring element;
wherein the PTC thermistors consist of individual wires which are arranged in a vertical plane between the PTC thermistor summing element and the ring element; and
wherein the spring element biases the ring element in a horizontal direction that is normal to the vertical plane with a force against the PTC thermistor summing element, thereby electrically connecting the PTC thermistors with the PTC thermistor summing element.

11. A measuring wheel for measuring at least one of a force and a torque on a wheel of a vehicle on which the measuring wheel is mounted, the measuring wheel comprising:
a plurality of transducer units;
wherein each of the plurality of transducer units includes a housing that defines an inside and an outside, wherein each of the plurality of transducer units includes a plurality of measuring units disposed in the inside of the housing and configured to generate an electrical charge under the effect of at least one of the force and torque to be measured by the measuring wheel;
wherein each of the plurality of transducer units includes a feedthrough attached to the housing and configured to conduct the electrical charge to the outside of the housing;
a plurality of electrical conductors disposed in the inside of the housing and configured to conduct the electrical charge from the plurality of measuring units to the feedthrough;
an additional feedthrough attached to the housing and configured to conduct an additional electrical charge from the outside of the housing into the inside of the housing; and
an additional electrical conductor disposed in the inside of the housing and configured to conduct the additional electrical charge from the additional feedthrough to the feedthrough.

12. The measuring wheel according to claim 11, wherein a first one of the plurality of transducer units includes a first measuring unit, a first electrical conductor electrically connected to the first measuring unit, a second measuring unit, and a second electrical conductor electrically connected to the second measuring unit;
wherein the feedthrough includes a NTC thermistor summing element electrically connected to each of the first and second electrical conductors; and
wherein the NTC thermistor summing element is configured to sum up electrical charge from the first and second measuring units so that the first one of the plurality of transducer units is configured to perform as a dual summing transducer unit.

13. The measuring wheel according to claim 12, wherein a second one of said plurality of transducer units includes a first measuring unit electrically connected to a first electrical conductor and a second electrical conductor electrically connected to a second measuring unit;
wherein said feedthrough includes a NTC thermistor summing element electrically connected to the first measuring unit and the first and second conductors of the second one of the plurality of transducer units;
wherein the additional electrical conductor is electrically connected to the NTC thermistor summing element;
wherein the NTC thermistor summing element is configured to sum electrical charge from the first and second measuring units and additional electrical charge from the additional feedthrough so that the second one of the plurality of transducer units is configured to perform as a first triple summing transducer unit.

14. The measuring wheel according to claim 13, further comprising an electronic circuit and a plurality of signal cables;
wherein said electronic circuit includes a further feedthrough;
wherein each signal cable defines a left cable end and a right cable end, and each of the left cable ends and right cable ends is configured to form a plug connection with one or more of the feedthrough, the additional feedthrough and the further feedthrough of the electronic circuit.

15. The measuring wheel according to claim 14, wherein the plurality of transducer units includes a second triple summing transducer unit, and a third triple summing transducer unit;
wherein the second triple summing transducer unit includes a first measuring unit electrically connected to a first electrical conductor, a second electrical conductor electrically connected to a second measuring unit, a feedthrough having a NTC thermistor summing element electrically connected to the first measuring unit and the first and second conductors, and an additional electrical conductor electrically connected to the NTC thermistor summing element, which is configured to sum electrical charge from the first and second measuring units and additional electrical charge from the additional feedthrough;
wherein the third triple summing transducer unit includes a first measuring unit electrically connected to a first electrical conductor, a second electrical conductor electrically connected to a second measuring unit, a feedthrough having a NTC thermistor summing element electrically connected to the first measuring unit and the first and second conductors, and an additional electrical conductor electrically connected to the NTC thermistor summing element, which is configured to sum electrical charge from the first and second measuring units and additional electrical charge from the additional feedthrough;
wherein the signal cables include a first signal cable, a second signal cable, a third signal cable, and a fourth signal cable;
wherein the first signal cable is connected with its left cable end to the feedthrough of the dual summing transducer unit and with its right cable end to the additional feedthrough of the first triple summing transducer unit;
wherein the second signal cable is connected with its left cable end to the feedthrough of the first triple summing transducer unit and with its right cable end to the additional feedthrough of the second triple summing transducer unit;
wherein the third signal cable is connected with its left cable end to the feedthrough of the second triple summing transducer unit and with its right cable end to the additional feedthrough of the third triple summing transducer unit; and
wherein the fourth signal cable is connected with its left cable end to the feedthrough of the third triple summing transducer unit and with its right cable end to the feedthrough of the electronic circuit.
